(19) United States
(12) Patent Application Publication
(10) Pub. No.: US 2003/0128386 A1
(43) Pub. Date: Jul. 10, 2003

(54) Method of setting a port and method of processing a job using the method of setting a port

(75) Inventor: Young-Hye Kim, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co. Ltd., Suwon-City (KR)

(21) Appl. No.: 10/300,596

(22) Filed: Nov. 21, 2002

(30) Foreign Application Priority Data
Jan. 7, 2002 (KR) 2002-705

(51) Int. Cl. B41J 1/00; G06F 15/00

(52) U.S. Cl. 358/1.15; 358/1.1

(57) ABSTRACT

A method of setting a port and a method of processing a job using the method of setting a port. In the method of setting at least one port through which a peripheral device is interlinked with a host, it is determined whether the host is physically interlinked with the peripheral device through a basic port of at least one port set as a default in the host. It is determined whether a port to physically interlink the host with the peripheral device exists if the host is not interlinked with the peripheral device through the basic port. The basic port is switched over to the port if it is determined that the port to physically interlink the host with the peripheral device exists. A user is informed that the port to physically interlinking] the host with the peripheral device does not exist if it is determined that the port to physically interlink the host with the peripheral device does not exist. If the host is not interlinked with the peripheral device through the basic port, it is searched whether an interlinked port to physically interlink the host with the peripheral device exists and the basic port can be switched over to the interlinked port automatically or by a user's permission.

### CROSS-REFERENCE TO RELATED APPLICATIONS

This application is based upon and claims priority from Korean Patent Application No. 02-705 filed Jan. 7, 2002 in the Korean Intellectual Property Office, the contents of which are incorporated herein by reference.

### BACKGROUND OF THE INVENTION

1. Field of the Invention

The present invention relates to a port used to connect a peripheral device and a host, and more particularly, to a method of setting a port and a method of processing a job using the method of setting a port.

2. Description of the Related Art

In general, when a peripheral device (not shown), i.e., a printer driver (not shown) to drive a printer, is installed in a host, a basic port is set in the printer driver. If a user of the host (not shown) instructs a printing job to the printer, printing data is transferred from the host to the printer through the basic port that is set as a default in the printer driver. In other words, the host and the printer transmit and receive data via the basic port. If the host is not interlinked with the printer via the basic port, the user cannot transmit the printing data through the basic port to the printer. In order to solve this problem, the user has to connect a data cable between the host and the printer directly to the basic port of the host. Also, the user directly searches for a port, to which a cable to physically interlink the host to the peripheral device is connected and then has to manually change the basic port into the interlinked port through programs. More specifically, the user deletes a current printing job, opens the printer driver registration information, manually changes the basic port through programs, and re-instructs the prior printing job through a corresponding application.

Finally, in a case where the basic port set in a corresponding printer driver is different from the port to physically interlink the host with the printer, i.e., the printer is not interlinked with the host through the basic port, the user has to manually change the basic port into the interlinked port using the printer driver registration information and the like. Thus, a conventional method of setting a port is complicated for the user, and burdens a primary user with a difficult job such as changing the printer driver registration information. As a result, errors may occur, and after-sale services related to the change of the port are a burden to the makers of the peripheral devices and hosts.

### SUMMARY OF THE INVENTION

Accordingly, it is an object of the present invention to provide a method of setting a port by which a basic port can be switched over to a physically interlinked port automatically or with permission or without permission from the user, and thus, the user does not need to physically, or through a program, change the basic port.

It is another object of the present invention to provide a method of processing a job that is instructed by a user using the method of setting a port.

Additional objects and advantages of the invention will be set forth in part in the description which follows and, in part, will be obvious from the description, or may be learned by practice of the invention.

The foregoing and other objects of the present invention are achieved by providing a method of setting at least one port through which a peripheral device is interlinked with a host. The method comprising: determining whether the host is physically interlinked with the peripheral device through a basic port or at least one port set as a default in the host, determining whether a port to physically interlink the host with the peripheral device exists if the host is not interlinked with the peripheral device through the basic port, switching over the basic port to the interlinked port if it is determined that the port to physically interlink the host with the peripheral device exists, and informing a user that the port to physically interlink the host with the peripheral device does not exist if it is determined that the port to physically interlink the host with the peripheral device does not exist.

In an aspect of the invention, it is determined whether the basic port is switched over to the interlinked port if it is determined that the port to physically interlink the host with the peripheral device exists, and switching over the basic port to the interlinked port if it is determined that the port to physically interlink the host with the peripheral device exists.

The foregoing and other objects of the present invention are also achieved by providing a method of processing a job using the method of setting a port, the method comprising: deleting the job if it is determined that the basic port is not switched over to the interlinked port, and processing the job if it is determined that the host is interlinked with the peripheral device through the basic port, or after the basic port is switched over to the interlinked port, or the user is informed that the port to physically interlink the host with the peripheral device does not exist.

### BRIEF DESCRIPTION OF THE DRAWINGS

These and other objects and advantages of the invention will become apparent and more readily appreciated from the following description of the embodiments, taken in conjunction with the accompanying drawings of which:

FIG. 1 is a flowchart illustrating a method of setting a port and a method of processing a job using the method of setting a port, according to an embodiment of the present invention; and

FIG. 2 is a block diagram illustrating a peripheral device driver to carry out the method of setting a port, which is described with reference to FIG. 1.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

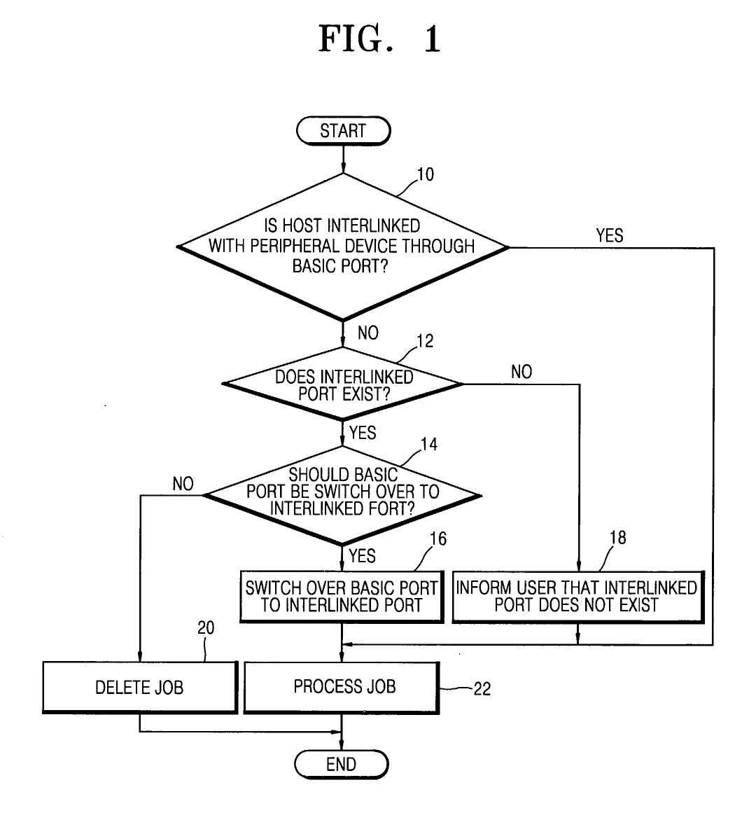

FIG. 1 is a flowchart illustrating a method of setting a port and a method of processing a job using the method of setting a port, according to the present invention. FIG. 1 includes operations 10 through 18 of setting a port and operations 20 and 22 of processing the job.

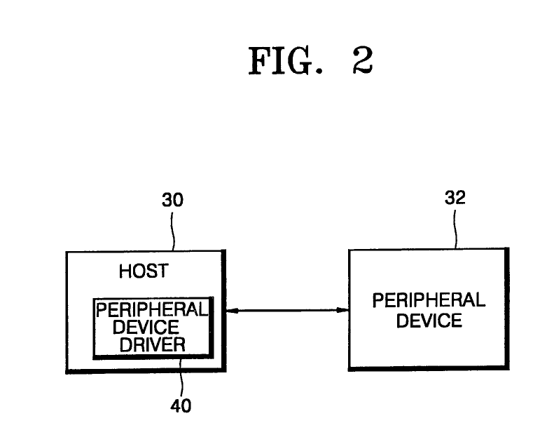

FIG. 2 is a block diagram illustrating a peripheral device driver 40 to carry out the method of setting a port, which is described with reference to FIG. 1, and comprises a host 30 and a peripheral device 32.

The host 30 and the peripheral device 32 illustrated in FIG. 2 are interlinked with each other through at least one port. Here, the peripheral device 32 may be a printer, a scanner, or a facsimile, and the port may be a LPT, USB, or the like. If the peripheral device 32 is the printer, the scanner, or the facsimile, the peripheral device driver 40 may be a printer driver, a scanner driver, or a facsimile driver.

A method of setting a port according to the present invention will be described in operations 10 through 18.

In operation 10, it is determined whether or not the host 30 is physically interlinked with the peripheral device 32 through a basic port that is set as a default in the host 30.

If it is determined that the host 30 is not interlinked with the peripheral device 32 through the basic port, it is then determined whether a port to physically interlink the host 30 with the peripheral device 32 exists in operation 12. To perform this operation, any ports capable of interlinking the host 30 with the peripheral device 32 are searched.

In this situation, if it is determined that a port to physically interlink the host 30 with the peripheral device 32 exists, it is then determined whether the basic port should be switched over to the interlinked port to physically interlink the host 30 via the peripheral device 32 in operation 14. In other words, since the port to physically interlink the host 30 with the peripheral device 32 exists, it is inquired of a user whether the basic port should be switched over to the interlinked port.

If the port to physically interlink the host 30 with the peripheral device 32 does not exist, the user is informed that the port to physically interlink the host 30 with the peripheral device 32 does not exist in operation 18. In this case, the user physically interlinks the host 30 with the peripheral device 32 through a desired port.

If it is determined that the basic port will be switched over to the interlinked port to physically interlink the host 30 with the peripheral device 32, the basic port is switched over to the interlinked port in operation 16.

The previously described method of setting a port according to an embodiment of the present invention may be performed in the peripheral device driver 40 of FIG. 2. The peripheral device driver 40 may be built in the host 30 and serves to drive the peripheral device 32. As described above, in a case where the method of setting a port is carried out in the peripheral device driver 40, the peripheral device driver 40 can carry out the method of setting the port when it monitors or drives the peripheral device 32. In this case, the monitoring is classified into two classes, language monitoring and port monitoring. In a case where the peripheral device driver 40 does not support bi-directional monitoring, such as during language monitoring of the peripheral device 32, e.g., a printer (not shown), the peripheral device driver 40 carries out the method of setting a port when driving the peripheral device 32, and not when monitoring the peripheral device 32.

In a method of processing a job using the previously described method of setting a port according to an embodiment of the present invention, a desired job that a user wants to perform using the peripheral device 32 is processed in operations 20 and 22.

Suppose that operation 10 is performed if a user of the host 30 wants to process a desired job using the peripheral device 32. Here, if it is determined that the basic port will not be switched over to a port to interlink the host 30 with the peripheral device 32 in operation 14, the job that the user desires to process is deleted in operation 20.

In the method of processing a job according to this embodiment of the present invention, if it is determined that the host 30 is interlinked with the peripheral device 32 through the basic port in operation 10, the job that the user desires to process is carried out in operation 22. Also, after operation 16, the job that the user desires to process may be carried out in operation 22. Further, after the user physically interlinks the host 30 with the peripheral device 32 through a port desired by a user in operation 18, the job that the user desires to process may be carried out in operation 22.

According to an embodiment of the present invention, if it is determined that the port to interlink the host 30 with the peripheral device 32 exists in operation 12, operation 14 is carried out to inquire of the user whether the basic port should be switched over to the interlinked port. Thus, the basic port can be changed only if the user desires.

However, according to another embodiment of the present invention, if it is determined that the port to interlink the host 30 with the peripheral device 32 exists in operation 12, operation 14 may be skipped and operation 16 may be carried out. In this case, the method of setting a port described with reference to FIG. 1 does not perform operation 14, and the method of processing a job does not perform operation 20. In other words, if it is determined that the port to physically interlink the host 30 with the peripheral device 32 exists in operation 12, the basic port is switched over to the port to physically interlink the host 30 with the peripheral device 32 in operation 16. Finally, the peripheral device driver 40 which exists in the host 30 checks all ports to search for any ports to physically interlink the host 30 with the peripheral device 32 if it is determined that the host 30 is not interlinked with the peripheral device 32 through the basic port. Here, if an interlinked port to physically interlink the host 30 with the peripheral device 32 exists, the basic port is automatically switched over to the interlinked port.

As described above, in a method of setting a port and a method of processing a job using the method of setting a port according to the embodiments of the present invention, if through a basic port, which is set to a default in the peripheral device driver 40, the host 30 is not interlinked with the peripheral device 32, it is determined whether an interlinked port to physically interlink the host 30 with the peripheral device 32 exists, and the basic port can be switched over to the interlinked port automatically or by a user's permission, or without a user's permission. Thus, the user can conveniently change the basic port into another port, and even users with little knowledge of changing of the basic port can also switch another port without errors. Further, burdensome and unnecessary after-sale services related to the changes of ports for makers of peripheral devices and hosts can be avoided.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of setting at least one port through which a peripheral device is interlinked with a host, the method comprising:
determining whether the host is physically interlinked with the peripheral device through a basic port or at least one port set as a default in the host;
determining whether a port to physically interlink the host with the peripheral device exists if the host is not interlinked with the peripheral device through the basic port;
switching over the basic port to the interlinked port upon determining that the port to physically interlink the host with the peripheral device exists; and
informing a user that the port to physically interlink the host with the peripheral device does not exist upon determining that the port to physically interlink the host with the peripheral device does not exist.

2. The method of claim 1, further comprising:
determining whether the basic port should be switched over to the interlinked port upon determining that the port to physically interlink the host with the peripheral device exists; and
switching over the basic port to the interlinked port upon determining that the basic port should be switched over to the interlinked port, otherwise, deleting a requested process job.

3. The method of claim 2, wherein in the informing the user that the port to physically interlink the host with the peripheral device does not exist, the user interlinks the host with the peripheral device through a desired port.

4. The method of claim 3, wherein the determining whether the host is physically interlinked with the peripheral device is performed upon determining that the user wants to process a desired job using the peripheral device.

5. The method of claim 1, wherein the host includes a peripheral device driver to drive the peripheral device and the method of setting a port is performed in the peripheral device driver.

6. The method of claim 5, wherein the method of setting a port is performed when the peripheral device driver monitors the peripheral device.

7. The method of claim 5, wherein the method of setting a port is performed when the peripheral device driver drives the peripheral device.

8. The method of claim 4, wherein processing of the job comprises:
deleting the job upon determining that the basic port is not switched over to the interlinked port in the determining whether the basic port is switched over to the interlinked port upon determining that the port to physically interlink the host with the peripheral device exists; and
processing the job upon determining that the host is interlinked with the peripheral device through the basic port or after either the switching over of the basic port to the interlinked port or after the user is informed that the port to physically interlink the host with the peripheral device does not exist.

9. The method of claim 1, wherein the basic port is switched over to the interlinked port automatically.

10. The method of claim 1, wherein the basic port is switched over to the interlinked port by a user's permission.

11. The method of claim 1, wherein the basic port is switched over to the interlinked port without a user's permission.

12. A method of setting at least one port through which a peripheral device is interlinked with a host, the method comprising:
determining whether the host is physically interlinked with the peripheral device through a basic port or at least one port set as a default in the host;
determining whether a port to physically interlink the host with the peripheral device exists if the host is not interlinked with the peripheral device through the basic port;
determining whether the basic port is switched over to the interlinked port upon determining that the interlinked port exists;
switching over the basic port to the interlinked port upon determining that the port to physically interlink the host with the peripheral device exists; and
informing a user that the port to physically interlink the host with the peripheral device does not exist upon determining that the port to physically interlink the host with the peripheral device does not exist.

13. A method of setting at least one port through which a peripheral device is interlinked with a host, the method comprising:
determining whether the host is physically interlinked with the peripheral device through a basic port or at least one port set as a default in the host;
determining whether a port to physically interlink the host with the peripheral device exists if the host is not interlinked with the peripheral device through the basic port; and
switching over the basic port to the interlinked port upon determining that the port to physically interlink the host with the peripheral device exists.
